(19) United States
(12) Patent Application Publication
(10) Pub. No.: US 2018/0137459 A1
(43) Pub. Date: May 17, 2018

(54) WAVELESS ORDER FULFILLMENT

(71) Applicant: Dematic Corp., Grand Rapids, MI (US)

(72) Inventors: Jeffrey M. Jacobs, Brookfield, WI (US); Arturo Diaz Hinojosa, New Berlin, WI (US)

(21) Appl. No.: 15/802,539

(22) Filed: Nov. 3, 2017

Related U.S. Application Data
(60) Provisional application No. 62/422,740, filed on Nov. 16, 2016.

(51) Int. Cl. G06Q 10/08; G06Q 10/04; G06Q 30/02; G06Q 30/06

(52) U.S. Cl. CPC G06Q 10/087; G06Q 30/0601; G06Q 30/02; G06Q 10/04

(57) ABSTRACT

A job fulfillment system and method includes a storage module having article storage and access to the article storage for retrieval of articles and a unit sortation module that is adapted to receive articles retrieved from the storage module and sorting those articles into jobs. A control system includes a storage module controller that is adapted to control operation of the storage module and a unit sortation module controller that is adapted to control operation of the unit sortation module. Both the storage module controller and the unit sortation module controller have a pending job queue and a priority policy that opens jobs in the respective pending job queue according to a policy. The unit sortation controller has a work-in-progress (WIP) controller that limits orders active in the unit sortation module to not exceed a configured capability of that module. Incoming jobs to the system are received with the unit sortation module pending job queue and jobs are activated with the sortation module controller from the sortation module pending job queue according to the policy of the sortation module control. Jobs that are active in the sortation module WIP controller are received with the storage module pending job queue and are activated with the storage module controller from the storage module pending job queue according to the policy of the storage module controller.

### CROSS-REFERENCE TO RELATED APPLICATIONS

This application claims priority from U.S. patent application Ser. No. 62/422,740, filed on Nov. 16, 2016, the disclosure of which is hereby incorporated herein by reference in its entirety.

### BACKGROUND OF THE INVENTION

The present invention is directed to order fulfillment systems and methods and, in particular, to pull-type order fulfillment systems and methods.

Order fulfillment of orders placed over the Internet must take place within a relatively short period of time in order to be commercially competitive. The same could be said for orders received by phone, facsimile, or by the mail based on catalog or television-based merchandizing. Such order fulfillment is known as E-commerce and places demands on an order fulfillment system to meet such obligations. This is compounded by the fact that E-commerce usually involves a large number of small orders (each containing as few as one item in the order) that are selected from a large number of potential items. Each unique item has a specific inventory identification, known in the industry as a stock-keeping unit (SKU). Each item usually bears an optical code, such as a barcode or radio frequency identification (RFID) tag that identifies the SKU of the item.

Traditional wave-based order fulfillment systems rely on batches of orders and buffers in the material-handling system to accumulate large quantities of items. This tends to produce unpredictable order cycle times, even under perfect conditions. This can best be seen in FIG. 5, which compares a simulation of a typical wave-based system under both idealized conditions A and real world conditions B. Even under idealized conditions, a significant number of orders are not fulfilled for 7500 seconds or more than two hours. When exceptions are added to the system in real world conditions, such as missing inventory, system faults, and other errors, the simulated order time can extend for up to twice that amount for some orders.

While other pull-type order fulfillment systems have been proposed, such pull-type systems make sure that all items making up an order arrive at packing within the same time window, but do not necessarily reduce the order cycle time. Furthermore, known pull-type systems may suffer from the same real world exceptions that dog the wave-type systems.

### SUMMARY OF THE INVENTION

The present invention fulfills orders very quickly within a warehouse in a real-time manner with high efficiency and flexibility. Also, buffering in the material-handling system is kept to a minimum. While useful even with manual processes, such as picking, the present invention makes the most of high automation; i.e., automated techniques for storing, retrieving, and sorting inventory items, or articles making up a customer order, within the warehouse. Orders can be added to the system and be provided high priority and urgency without disrupting the system and while allowing orders to meet shipping windows, if necessary. As used in the following discussion, the term “job” is intended to refer to individual request at a module such as an order, an order line, or an item. The term “work” is intended to refer to one or more jobs. The term “order” is intended to refer to a job for one customer.

An order fulfillment system and method, according to an aspect of the invention, includes a storage module having article storage and access to the article storage for retrieval of articles and a unit sortation module that is adapted to receive articles retrieved from the storage module and sort those articles into orders. A control system includes a storage module controller that is adapted to control operation of the storage module and a unit sortation module controller that is adapted to control operation of the unit sortation module. Both the storage module controller and the unit sortation module controller have a pending work or job queue, such as a pending order queue and a priority policy that activates orders in the respective pending work queue according to a policy. The unit sortation module controller includes a work-in-progress (WIP) controller that limits jobs, such as orders, active in the unit sortation module to not exceed a configured capability. Incoming jobs to the system are received with the unit sortation module pending job queue and jobs are activated with the unit sortation module WIP controller from the unit sortation module pending job queue according to the policy of the sortation module control, provided that the job limit of the unit sortation module WIP controller is not reached. Jobs that are active in the unit sortation module WIP controller are received with the storage module pending order queue and are activated with the storage module controller from the storage module pending order queue according to the policy of the storage module control.

The storage module controller may include a work-in-progress (WIP) controller that limits work or jobs such as orders active in the storage module to not exceed another configured capability and the storage module controller may activate jobs from the storage module pending job queue according to the policy of the storage module control provided that the job limit of the storage module WIP controller is not met. The unit sortation module WIP controller may limit activated jobs according to a number of articles in the jobs. The storage module may be an automated warehouse and include a storage and retrieval mechanism that is adapted to store articles to the article storage and to retrieve articles from article storage to provide access to that article. A material flow system may be provided that is adapted to convey retrieved articles from the unit induct module to the unit sortation module. A unit induct module may be adapted to receive articles retrieved by the article storage buffer and induct the articles to the material flow system. The material flow system may be an overhead supported pouch system.

A plurality of the unit induct modules and a plurality of unit sortation modules may be provided with the material flow system being adapted to transfer articles from any of the unit induct modules to any of the unit sortation modules. A plurality of storage modules may be provided, with each of the unit induct modules receiving articles from one of the storage modules.

Articles may be stored in receptacles in the storage module wherein a receptacle having an article is retrieved in order to retrieve that article. A receptacle having articles for multiple jobs that are active in the storage module WIP controller may be retrieved once in order to retrieve articles for the multiple jobs.

A plurality of pack stations may be provided, each adapted to receive articles making up an order sorted by the unit sortation module and facilitate packing of the articles making up an order. A pack sorter may be provided between the unit sortation module and the pack stations. The unit sortation module is adapted to sort articles into groups of orders and the pack sorter is adapted to sort groups of orders to individual orders at each of the pack stations.

The unit sortation module may be a comb sorter having an article input, a plurality of sorter lanes and at least one diverter that is adapted to divert articles from the article input to one of the sorter lanes. Each of the sorter lanes may be adapted to receive a maximum number of orders. The number of pack stations may be greater than or equal to the maximum number of orders that can be received at each sorter lane. The unit sortation module controller may assign activated orders to a sorter lane until the number of orders in that lane reaches its maximum number of orders before assigning an activated order to a different lane. An order dispatched from the unit sortation module to one of the pack stations may be subtracted from the number of activated orders in the unit sortation module.

The unit sortation module may include another comb sorter. The another comb sorter has another article input, a plurality of other sorter lanes and at least one other diverter that is adapted to divert articles from the other article input to one of said another sorter lanes. Each of the other sorter lanes may be adapted to receive a maximum number of orders and may be adapted to supply articles to the article input of the downstream comb sorter. Each of the other lanes' maximum number of orders may be greater than the number of pack stations. The unit sortation module controller may assign activated orders to one of the other lanes until the number of orders in that lane reaches its maximum number of orders before assigning an activated order to a different another lane.

These and other objects, advantages and features of this invention will become apparent upon review of the following specification in conjunction with the drawings.

### BRIEF DESCRIPTION OF THE DRAWINGS

FIG. 1 is a block diagram of an order fulfillment system and method according to an embodiment of the invention;

FIG. 2 is a more detailed block diagram of the order fulfillment system and method embodiment shown in FIG. 1;

FIG. 3 is yet a more detailed block diagram of a portion of the order fulfillment system and method shown in FIGS. 1 and 2;

FIG. 4 is a block diagram of the order fulfillment system and method in FIG. 1 illustrating information flow and article flow in the order fulfillment system and method;

FIG. 5 is a cycle time histogram simulation of order fulfillment time distribution in a prior art order fulfillment system and method;

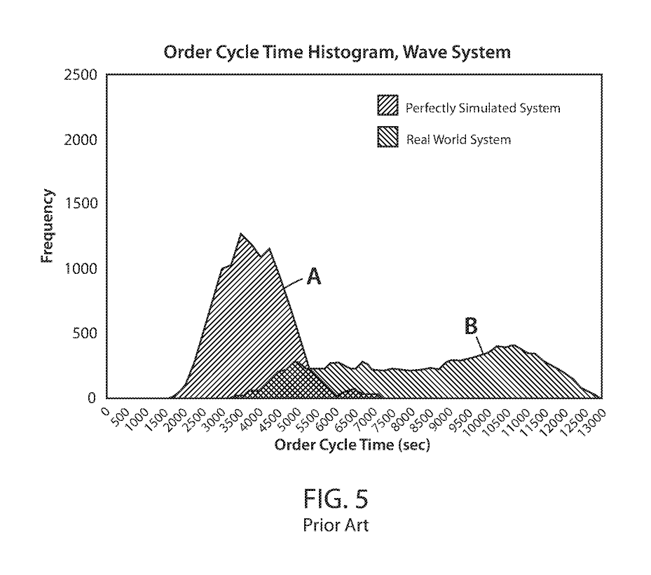

FIG. 6 is a cycle time histogram simulation of an order fulfillment time distribution of an order fulfillment system according to embodiments of the present invention;

FIG. 7 is a schematic diagram of a single-stage comb unit sortation module; and

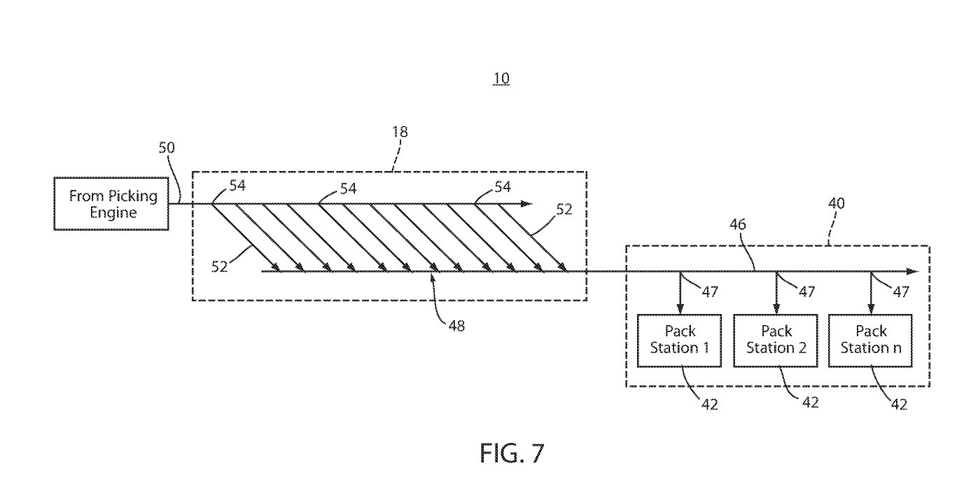

FIG. 8 is a schematic diagram of a two-stage comb unit sortation module.

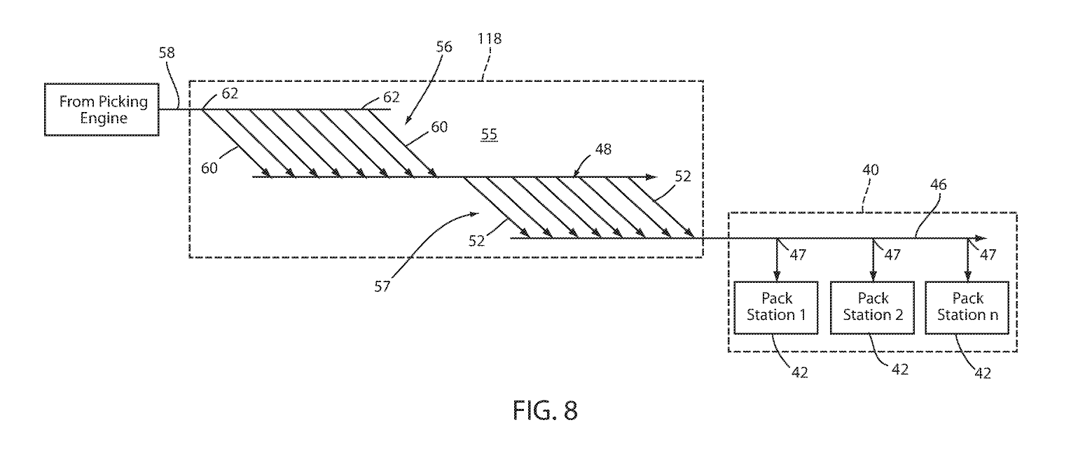

### DESCRIPTION OF THE PREFERRED EMBODIMENT

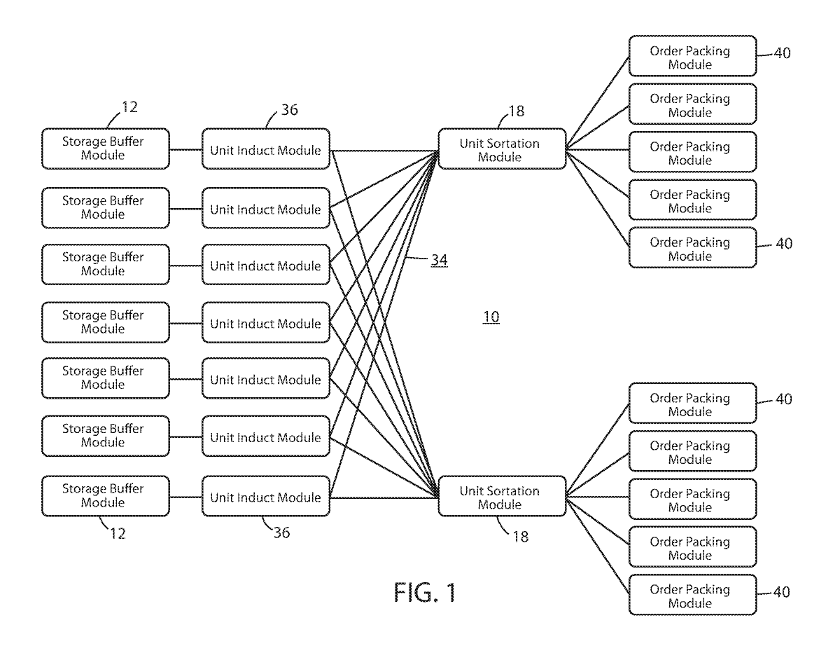

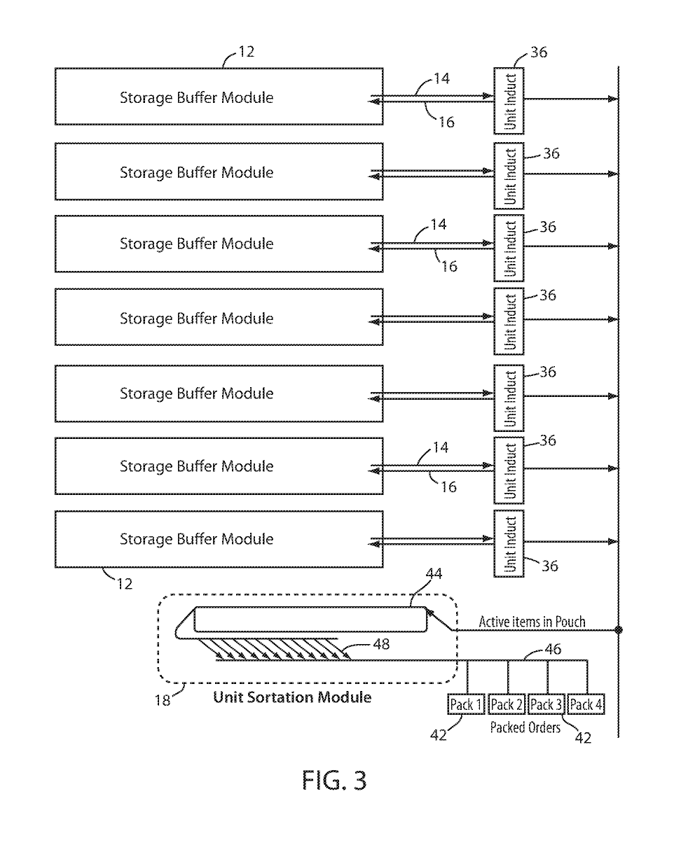

Referring now to the drawings and the illustrative embodiment depicted therein, an order fulfillment system 10 includes a storage module 12 and a unit sortation module 18 (FIGS. 1-3). Storage module 12 has article storage and access to the article storage for retrieval of articles. In the illustrated embodiment, storage module 12 is an automated warehouse, such as a Dematic Multishuttle® system which is a multi-tier automated warehouse of the type disclosed in commonly assigned U.S. Pat. No. 8,974,168, the disclosure of which is hereby incorporated herein by reference in its entirety, or a unit load or ASRS system of the type marketed by Dematic Corp. under the Typhoon® brand. However, storage module 12 could, alternatively, be a manual type storage and retrieval system or of the type using inventory holders that are transported by robotic module drive units. Unit sortation module 18 receives articles retrieved from storage module 12 and sorts those articles into orders, such as customer orders fulfilled in e-commerce. The techniques disclosed herein may be used for other applications, such as retail store fulfillment, and the like.

In the illustrated embodiment, articles are stored in storage module 12 in receptacles, such as totes, trays, cartons, or the like, and are discharged from storage modules on a discharge lane 14 and, when one or more articles are retrieved from the receptacle, is returned to storage via a storage lane 16. Such receptacles could each contain an individual type of article, or stock keeping unit (SKU), or could contain a heterogeneous mixture of different SKUs.

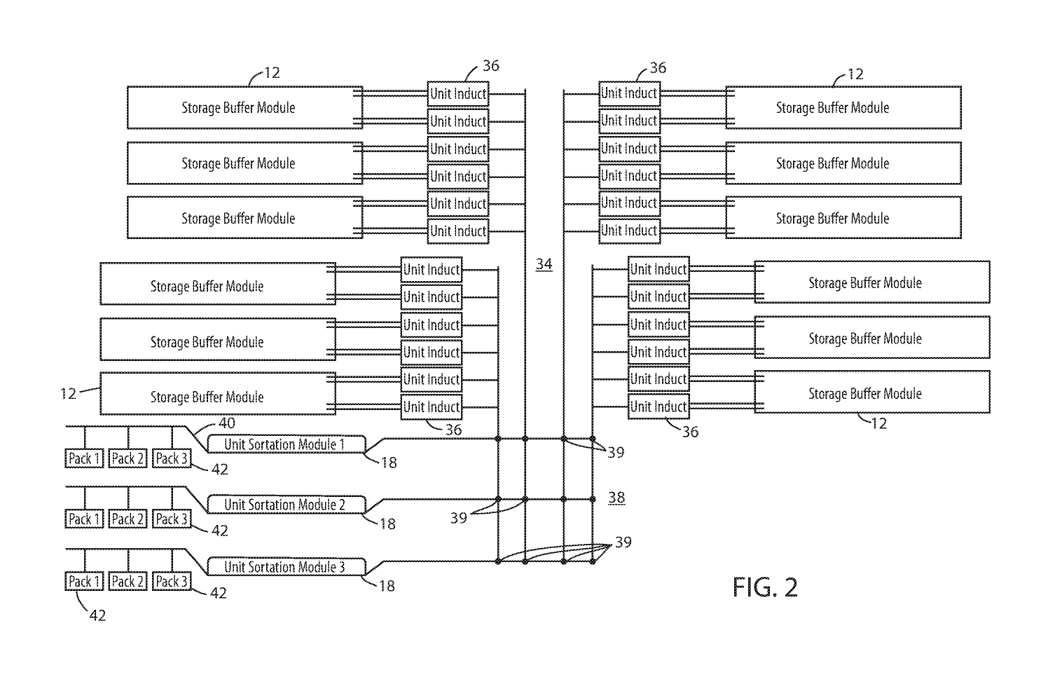

A unit induct module 36 receives articles in receptacles retrieved by the article storage module 12 and inducts the articles. A material flow system 34 transports articles from unit induct module 36 to sortation module 18. In the illustrated embodiment, material flow system 34 is an overhead supported pouch system of the type marketed by Dematic Corp. under the MonaLisa brand or the type marketed by others including Dürkopp Fördertechnik GmbH. However, other types of material flow systems can be used. Each unit induct module 36 may be an automatic induction station or manual induct station. Order fulfillment system 10 includes a plurality of unit induct modules 36 and a plurality of unit sortation modules 18, wherein material flow system 34 may transport articles from any one or more of the unit induct modules to any of the unit sortation modules. As best seen in FIG. 2, this may be accomplished by a matrix 38 of diverters 39. Each of the unit induct modules 36 receives articles from one or more of the storage modules 12. More than one induct module 36 may be provided for each storage module.

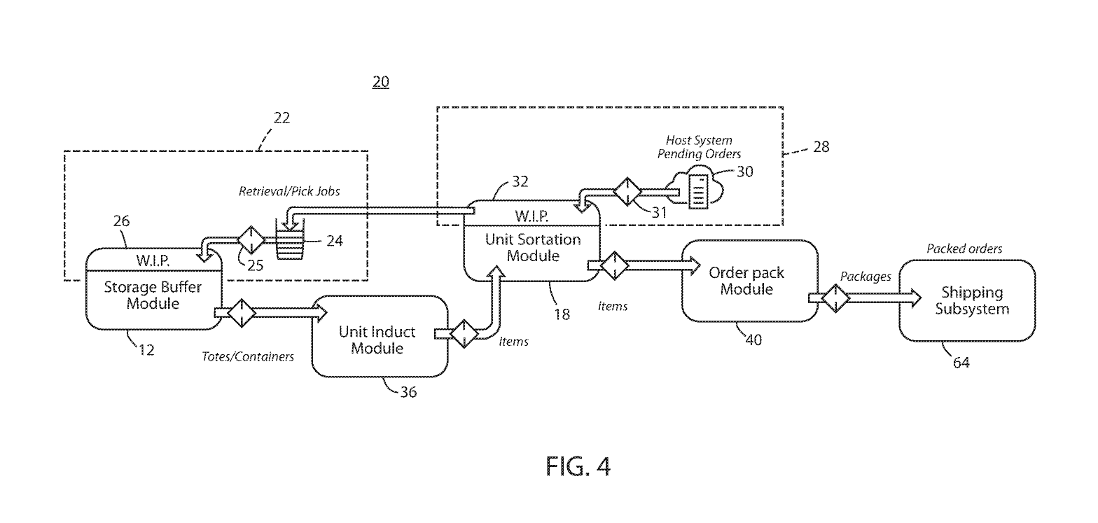

Order fulfillment system 10 has a control system 20 that includes a storage module controller 22 and a unit sortation module controller 28 (FIG. 4). Storage module controller 22 and unit sortation module controller 28 may be logical controllers defined by software or may be otherwise defined in hardware. Storage module controller 22 has a pending order queue 24 and a priority policy 25 that opens or activates orders in queue 24 according to a policy that is selectable by the system operator. Unit sortation module controller 28 has a pending order queue 30 and a priority policy 31 that opens orders in the respective pending order queue 30 according to a policy. Examples of priority policy may be a combination of order urgency, which is how close an order is to its desired ship window, and/or order priority, which is how important the order is and, therefore, should receive expedited processing. Unit sortation module controller 28 has a work in progress (WIP) controller 32 that limits orders that are active in the unit sortation module to not exceed a configured capability. Such WIP controller releases a new job each time a single job is completed. The configured capability of controller 32 may be configured to the physical capacity of the unit sortation module but can also be configured to a different value to achieve different system benefits. For example, the configured capability can be set below physical capacity of the unit sortation module in order to provide faster cycle time. Alternatively, the configured capability of WIP controller 28 can be set above physical capacity of the unit sortation module for maximum optimization potential.

Storage module controller 22 may additionally have a work in progress (WIP) controller 26 that limits orders that are active in the storage module to not exceed a configured capability. Such configured capability may be related to the physical capacity of the module and may be set either at the physical capacity or above or below it. Once the number of active orders is reached, no additional orders are activated until orders are completed and the work in progress falls below the limit. The use of WIP modules activates small amounts of orders, and each time an order is completed in the module, a new order is added to the module. This yields fast and predictable order cycle time. This also reduces the need for buffers throughout conveying system 34.

Sortation module pending order queue 30 receives orders incoming to the system 10. Sortation module WIP controller 32 activates orders from the sortation module pending order queue 30 according to the activation policy 31 of the sortation module control provided that the order limit of the sortation module WIP controller is not reached. Having a WIP controller with unit sortation controller 28 provides a pull-type system. The storage module pending order queue 24 receives orders that are active in the sortation module WIP controller 32. The storage module WIP controller 26 activates orders from the storage module pending order queue 24 according to the activation policy 25 of the storage module control provided that the order limit of the storage module WIP controller is not met. As orders are fulfilled by the storage buffer module, additional orders may be activated from queue 24. Once an order is active in storage module WIP controller 26, a retrieval mission is issued to the retrieval mechanism, such as a shuttle, unit load carrier or the like. If another order has already requested the same receptacle, no additional retrieval is necessary. When that receptacle arrives at the unit induct module 36, all picks for all active orders across all unit sortation modules 18 will be made from the single receptacle. If all of the inventory in the receptacle is fully claimed, additional receptacles will then be retrieved.

Each unit sortation module 18 supplies an order pack module 40 made up of a plurality of pack stations 42 and a pack sorter 46. Each pack station 42 receives a stream of articles making up an order sorted by the unit sortation module so that an operator, which may be manual or automated, can pack the articles making up that order. The packed order can then go directly or indirectly to a shipping subsystem 64 where it is dispatched to transportation. Pack sorter 46 receives a stream of articles from the unit sortation module made of the articles for a number of orders with the articles intermixed for each order. However, no more orders than the number of pack stations 42 are discharged from the unit sortation module at a time. As those articles arrive at pack sorter 46, which is made up of transfer switches 47, the transfer switches selectively transfers articles to an associated pack station 42. The articles for an order, which are intermixed with articles for others arriving at pack sorter 46 are diverted out of the stream of articles to the pack station. In this manner, the articles for a particular order are together at the pack station although multiple orders may be backed up for each pack station. Unit sortation module 18 will not release a stream of articles for a plurality of orders unless there is room for those articles at the pack stations and each pack station can only be assigned one order from a single discharge stream from the unit sortation module. The sequence of articles at the pack stations will be in order sequence. However, if an order requires a particular arrangement of items within an order, such as heavy items first, a separate provision will be required to provide such arrangement.

In the illustrated embodiment, each unit sortation module 18 is made up of a comb sorter 48 having an article input 50 and a plurality of sorter lanes 52. However other types of unit sortation modules such as a matrix sorter of the type disclosed in U.S. Pat. No. 5,798,800, the disclosure of which is hereby incorporated herein by reference in its entirety, may be used. A diverter 54 at each lane 52 selectively diverts articles from article input 50 to that lane. An optional buffer 44 may be provided upstream of article input 50. Optional buffer 44 is a dynamic buffer that is provided only in case there is a temporary over-feed of articles to the comb sorter. It performs no part in the organization of articles into order, but is there to handle any temporary overflow so that conveyor lines do not need to be shut down if such temporary overflow should occur. Normally, once a rate of order fulfillment is exceeded at a unit sortation module, another unit sortation module is selected and each unit induct module 36 has a path to each unit sortation module 18. This is accomplished by matrix 38 made up of rows and columns with diverters 39 at the intersection of each row and column to provide this ability of each unit induct module to have a path to each unit sortation module.

Unit sortation module controller 28 controls comb sorter 48 so that an order is assigned to one lane 52. However, each lane can receive more than one order up to a maximum number of orders. The maximum number of orders that each lane can receive is less than or equal to the number of pack stations 42, so that the number of pack stations is greater than or equal to the maximum number of orders that can be received at each sortation lane 52. Unit sortation module controller 28 assigns activated orders to a lane 52 until the number of orders in that lane reaches its maximum number of orders before assigning an activated order to a different lane 52. All items must be stored in a lane without reaching its physical capacity or else that order will not be assigned to that lane. In this event, the sort lane 52 will no longer accept additional orders and will be ready to release its articles to pack stations. In order to release a sort lane to the pack stations, the pack stations must have capacity to accept an additional order for that lane to be released. The pack stations having the most capacity are selected to receive the orders from the released sort lane, but with no more than one order going to any pack station from that release.

Thus, the order pack modules 40 represent the last process in the system. The pack station module receives all of the items for a customer order and facilitates an operator placing them into a shippable container for the customer. The process flow supports any ratio of unit sortation modules and order pack modules, and the type of equipment used will influence the rate. Typically, the unit sortation module will have a much higher rate than a single order pack module.

When an order is dispatched from unit sortation module 18 to one of the pack stations 42, it is subtracted from the number of activated orders in the unit sortation module in WIP controller 32. Therefore, another order can be activated. For example, if ten orders are released from a sort lane 52 to pack stations 42, then ten additional orders can be activated by WIP controller 32. Information of the ten orders that are activated by WIP controller 32 is sent to the storage module controller 22 for placement in the pending order queue 24 where they will be activated by the storage module WIP controller 26 according to activation policy 25. Activated orders are limited according to the number of articles in the orders so that fewer large orders may be active than more small orders.

Alternatively, a unit sortation module 118 may include an alternative comb sorter 55. Comb sorter 55 is a two-stage continuous flow comb sorter. Comb sorter 55 has a first-stage comb sorter 56 and a second-stage comb sorter 57. Second-stage comb sorter 57 operates in a similar fashion to comb sorter 48. First-stage comb sorter 56 has an article input 58, a plurality of sort lanes 60 and diverters 62 that divert articles from article input 58 to one of lanes 60. Each of lanes 60 can receive a maximum number of orders, but, unlike comb sorter 48, the maximum number of orders in each sort lane 60 may exceed the number of pack stations 42. Article input 58 receives articles from a unit induct module via switch matrix 38 and each sort lane supplies articles to article input 50 of second-stage comb sorter 57.

Unit sortation module controller 28 assigns activated orders to one of lanes 60 until the number of orders in that lane reaches its maximum number of orders before assigning an activated order to a different sort lane 60. Once the first articles of an order is assigned to a sort lane 60, all other articles for that order will also be routed to the same sort lane in first-stage comb sorter 56. This fills a sort lane 60 as rapidly as possible before assigning other orders to different sort lanes 60 in the first-stage comb sorter. When all of the articles for all of the orders of a sort lane 60 are present, that sort lane discharges to second-stage comb sorter 57. Orders are assigned to lanes 52 of comb sorter 57 in the same manner as to the order assignment for single-stage comb sorter 48. However, the orders discharged from a sort lane 60 of first-stage comb sorter 56 may be sent to multiple different lanes of second-stage comb sorter 57, thus allowing more orders to be assigned to each sort lane 60 in the first-stage comb sorter than the sort lanes 52 second-stage comb sorter 57 and, hence, more than the number of pack stations 42. Thus, the option of using a two-stage comb sorter 55 allows system design which provides scalability without requiring many additional comb sorter lanes 52 and is not limited by the number of pack stations 42.

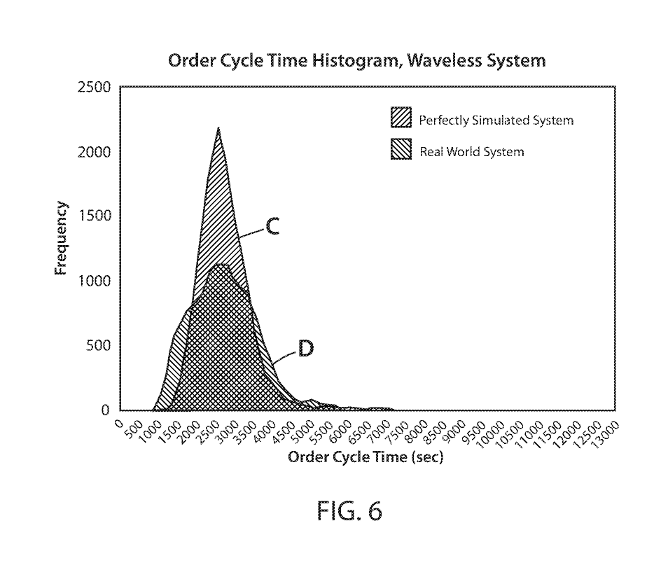

Simulated responses of an order fulfillment system and method according to embodiments of the invention for both idealized conditions C and real world conditions D are shown in FIG. 6. A much greater overlap between idealized and real world is realized and most orders are fulfilled within one hour. Very few orders are not fulfilled within an hour and a half.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

1. An order fulfillment system, comprising:
a storage module having article storage and access to the article storage for retrieval of articles;
a unit sortation module adapted to receive articles retrieved from the storage module and sorting those articles into orders;
a control system comprising a storage module controller that is adapted to control operation of said storage module and a unit sortation module controller that is adapted to control operation of said unit sortation module, both said storage module controller and said unit sortation module controller having a pending job queue and a priority policy that opens jobs in the respective pending job queue according to a policy; and
said unit sortation module controller including a work-in-progress (WIP) controller that limits jobs active in the unit sortation module to not exceed a configured capability, wherein said sortation module pending job queue is adapted to receive jobs incoming to the system and the unit sortation module WIP controller activates jobs from the unit sortation module pending job queue according to the policy of the unit sortation module control provided that the job limit of the unit sortation module WIP controller is not reached and said storage module pending job queue is adapted to receive jobs that are active in the unit sortation module WIP controller and the storage module controller activates jobs from the storage module pending job queue according to the policy of the storage module control.

2. The order fulfillment system as claimed in claim 1 wherein said storage module controller including a work-in-progress (WIP) controller that limits jobs active in the storage module to not exceed another configured capability and wherein the storage module controller activates jobs from the storage module pending job queue according to the policy of the storage module control provided that the job limit of the storage module WIP controller is not met.

3. The order fulfillment system as claimed in claim 1 wherein the unit sortation module WIP controller activates jobs according to a number of articles in the jobs.

4. The order fulfillment system as claimed in claim 1 wherein said storage module comprises an automated warehouse and includes a storage and retrieval mechanism that is adapted to store articles to the article storage and to retrieve articles from the storage to provide access to that article.

5. The order fulfillment system as claimed in claim 1 including a material flow system that is adapted to transport articles to said unit sortation module and a unit induct module that is adapted to receive articles retrieved by the article storage buffer and induct the articles to said material flow system.

6. The order fulfillment system as claimed in claim 5 wherein said material flow system comprises an overhead supported pouch system.

7. The order fulfillment system as claimed in claim 5 including a plurality of said unit induct modules and a plurality of said unit sortation modules wherein said material flow system is adapted to convey articles from any of said unit induct modules to substantially any of said unit sortation modules.

8. The order fulfillment system as claimed in claim 7 including a plurality of said storage modules, each of said unit induct modules receiving articles from one of said storage modules.

9. The order fulfillment system as claimed in claim 2 wherein articles are stored in receptacles in said storage module and wherein a receptacle having an article is retrieved in order to retrieve that article.

10. The order fulfillment system as claimed in claim 9 wherein a receptacle having articles for multiple jobs that are active in said storage module WIP controller is retrieved once in order to retrieve the articles for the multiple jobs.

11. The order fulfillment system as claimed in claim 2 wherein said configured capability is selectable as a function of physical capability of said unit sortation module and said another configured capability is selectable as a function of physical capacity of said storage module.

12. The order fulfillment system as claimed in claim 1 wherein said configured capability is selectable as a function of physical capacity of said unit sortation module.

13. The order fulfillment system as claimed in claim 1 including a plurality of pack stations each adapted to receive articles making up an order sorted by the unit sortation module and facilitate packing of the articles making up an order.

14. The order fulfillment system as claimed in claim 13 including a pack sorter between said unit sortation module and said pack stations, wherein said unit sortation module is adapted to sort articles into groups of orders and said pack sorter is adapted to sort articles for groups of orders to articles for individual orders at each of the pack stations.

15. The order fulfillment system as claimed in claim 13 wherein said unit sortation module comprises a comb sorter having an article input, a plurality of lanes and at least one diverter that is adapted to divert articles from said article input to one of said lanes.

16. The order fulfillment system as claimed in claim 15 including a buffer upstream of said article input.

17. The order fulfillment system as claimed in claim 15 wherein each of said lanes is adapted to receive a maximum number of orders.

18. The order fulfillment system as claimed in claim 17 wherein the number of pack stations is greater than or equal to the maximum number of orders that can be received at each of said lanes.

19. The order fulfillment system as claimed in claim 15 wherein said unit sortation module controller assigns activated orders to a lane until the number of orders in that lane reaches its maximum number of orders before assigning an activated order to a different lane.

20. The order fulfillment system as claimed in claim 15 wherein an order dispatched from said unit sortation module to one of said pack stations is subtracted from the number of active orders in the unit sortation module.

21. The order fulfillment system as claimed in claim 15 wherein said unit sortation module comprises another comb sorter, said another comb sorter having another article input, a plurality of other lanes and at least one other diverter that is adapted to divert articles from said other article input to one of said another lanes and wherein each of said another lanes adapted to supply articles to said article input of said comb sorter.

22. The order fulfillment system as claimed in claim 21 wherein each of said another lanes is adapted to receive a maximum number of orders and wherein each of said another lanes is adapted to supply articles to said article input of said comb sorter.

23. The order fulfillment system as claimed in claim 22 wherein each of said another lanes is adapted to receive a maximum number of orders that is greater than the number of pack stations.

24. The order fulfillment system as claimed in claim 21 wherein said unit sortation module controller assigns activated orders to another lane until the number of orders in that another lane reaches its maximum number of orders before assigning an activated order to a different another lane.

25. An order fulfillment system, comprising:
a storage module having article storage and access to the article storage for retrieval of articles;
a unit sortation module adapted to receive articles retrieved from the storage module and sorting those articles into orders; and
a plurality of pack stations each adapted to receive articles making up an order sorted by the unit sortation module and facilitate packing of the articles making up an order,
wherein said unit sortation module comprises a comb sorter having an article input, a plurality of lanes and at least one diverter that is adapted to divert articles from said article input to one of said lanes; and
a control system comprising a storage module controller that is adapted to control operation of said storage module and a unit sortation module controller that is adapted to control operation of said unit sortation module.

26. The order fulfillment system as claimed in claim 25 wherein each of said lanes is adapted to receive a maximum number of orders.

27. The order fulfillment system as claimed in claim 26 wherein the number of pack stations is greater than or equal to the maximum number of orders that can be received at each of said lanes.

28. The order fulfillment system as claimed in claim 25 wherein said unit sortation module controller assigns activated orders to a lane until the number of orders in that lane reaches its maximum number of orders before assigning an activated order to a different lane.

29. The order fulfillment system as claimed in claim 25 wherein an order dispatched from said unit sortation module to one of said pack stations is subtracted from the number of activated orders in the unit sortation module.

30. The order fulfillment system as claimed in claim 25 including a buffer upstream of said article input.

31. The order fulfillment system as claimed in claim 25 wherein said unit sortation module comprises another comb sorter, said another comb sorter having another article input, a plurality of other lanes and at least one other diverter that is adapted to divert articles from said other article input to one of said another lanes and wherein each of said another lanes is adapted to supply articles to said article input of said comb sorter.

32. The order fulfillment system as claimed in claim 31 wherein each of said another lanes is adapted to receive a maximum number of orders and wherein each of said another lanes is adapted to supply articles to said article input of said comb sorter.

33. The order fulfillment system as claimed in claim 32 wherein each of said another lanes is adapted to receive a maximum number of orders that is greater than the number of pack stations.

34. The order fulfillment system as claimed in claim 31 wherein said unit sortation module controller assigns activated orders to another lane until the number of orders in that lane reaches its maximum number of orders before assigning an activated order to a different another lane.

35. The order fulfillment system as claimed in claim 31 including a pack sorter between said unit sortation module and said pack stations, wherein said unit sortation module is adapted to sort articles into groups of orders and said pack sorter is adapted to sort groups of orders to individual orders at each of the pack stations.

36. An order fulfillment method for use with a storage module having article storage and access to the article storage for retrieval of articles and a unit sortation module adapted to receive articles retrieved from the storage module and sorting those articles into orders, said method comprising:
having a control system comprising a storage module controller and a unit sortation module controller, both said storage module controller and said unit sortation module controller having a pending job queue, a priority policy that opens jobs in the respective pending job queue according to a policy;
said unit sortation module controller having a work in progress (WIP) controller that limits jobs active in the unit sortation module to not exceed physical capability of that module, said unit sortation controller receiving jobs incoming to the system with said sortation module pending job queue and activating jobs with the sortation module WIP controller from the sortation module pending job queue according to the policy of the sortation module control; and
receiving jobs that are active in the unit sortation module WIP controller with said storage module pending job queue and activating jobs with the storage module controller from the storage module pending job queue according to the policy of the storage module control.
